(19) United States
(12) Patent Application Publication
(10) Pub. No.: US 2026/0217553 A1
(43) Pub. Date: Jul. 30, 2026

(54) METHOD FOR SHORT-PROCESS PREPARATION OF HETEROPOLY ACID FROM SCHEELITE AND ITS APPLICATION IN REDOX FLOW BATTERY

(71) Applicant: Central South University, Changsha (CN)

(72) Inventors: Chenyang ZHANG, Changsha (CN); Mingjun HAN, Changsha (CN); Jie LI, Changsha (CN); Wei SUN, Changsha (CN); Wenjihao HU, Changsha (CN)

(73) Assignee: Central South University, Changsha (CN)

(21) Appl. No.: 19/426,122

(22) Filed: Dec. 19, 2025

(30) Foreign Application Priority Data
Jan. 25, 2025 (CN) 2025101201928

(51) Int. Cl. C01G 41/02; C22B 3/04; C22B 3/22; C22B 3/26; C22B 3/44; H01M 8/18

(52) U.S. Cl. CPC C01G 41/02; C22B 3/04; C22B 3/22; C22B 3/302; C22B 3/44; H01M 8/18; C01P 2006/40

(57) ABSTRACT

A method for short-process preparation of a heteropoly acid from scheelite and its application in redox flow battery are provided. The method includes: S1, mixing the scheelite with sodium silicate at a W-to-Si molar ratio of (1-3):1, and conducting water leaching and acidolysis; and conducting solid-liquid separation to remove insoluble substances; S2, adding a precipitating agent to a leachate to produce a silicotungstate precipitate, thereby achieving salt precipitation-based purification of silicotungstic acid with a Keggin structure; and S3, redissolving the silicotungstate precipitate obtained in S2, and conducting acidification, extraction, and recrystallization to produce Keggin-type silicotungstic acid with a battery-grade purity. A method for direct short-process production of a heteropoly acid electrolyte in a redox flow battery through in-situ decomposition of scheelite is further provided. This method achieves the clean and efficient utilization of tungsten resources, and significantly reduces the production cycle and cost of redox flow battery electrolytes.

### CROSS REFERENCE TO THE RELATED APPLICATIONS

This application is based upon and claims priority to Chinese Patent Application No. 202510120192.8, filed on Jan. 25, 2025, the entire contents of which are incorporated herein by reference.

### TECHNICAL FIELD

The present disclosure relates to an application of scheelite, and specifically relates to a method for short-process preparation of a heteropoly acid from scheelite and its application in redox flow battery.

### BACKGROUND

With the extensive utilization of renewable clean energy and the growing demand for long-duration energy storage globally, redox flow batteries (RFBs) have gradually garnered widespread attention as a safe, efficient, and long-lasting energy storage technology. Currently, the widely studied RFBs mainly include all-vanadium (VRFBs), all-iron (Fe-RFBs), iron-chromium (Fe—Cr RFBs), zinc-bromine (Zn—Br RFBs), zinc-manganese (Zn—Mn RFBs), heteropoly acid-based RFBs, etc.

The electrolyte is one of the key components of redox flow battery. Thus, the performance of electrolyte directly affects the capacity, energy density, stability, and cycling life of the redox flow battery. The preparation of high-performance electrolytes often relies on complex chemical synthesis processes, which involve long cycles and high costs. In addition, during the production of high-performance electrolytes, harmful by-products may be generated, posing a threat to the environment.

More importantly, VRFBs, Fe—Cr RFBs, and Zn—Br RFBs that have gradually been commercialized still face significant challenges such as low energy density and limited capacity because these RFBs achieve charge storage merely relying on single-electron/two-electron redox reactions.

Heteropoly acids, as charge carriers, present unique advantages in the field of electrochemical energy storage. Due to multi-electron redox characteristics, strong stability, high solubility, tunable redox potential, and customizable structures, heteropoly acids demonstrate huge potential for enhancing the energy density of RFBs. However, traditionally, heteropoly acids are prepared using high-purity chemical reagents. The traditional preparation technology exhibits significant disadvantages such as a lengthy process, high cost, and low efficiency, which severely limits the development of heteropoly acids-based RFBs.

Tungsten ore, as a non-renewable strategic scarce resource, plays a crucial role in fields including military industry, electronics, aerospace, chemical engineering, and biomedicine. However, the production of tungsten chemicals such as tungstic acid, sodium tungstate, calcium tungstate, ammonium metatungstate (AMT), and ammonium paratungstate (APT) through a complex process including exploration, mining, beneficiation, smelting, and processing of scheelite for downstream applications is time-consuming and energy-intensive, remains costly, and places enormous pressure on the environment. How to shorten a processing flow, reduce a production cost, and achieve the efficient utilization of tungsten resources while causing no environmental pollution remains a significant challenge in the field of clean and efficient tungsten metallurgy.

Therefore, there is an urgent need to establish a systematic technique linking the efficient and clean utilization of scheelite and the short-process and low-cost preparation of electrolytes for heteropoly acid-based RFBs, so as to provide a new solution for long-duration energy storage technologies, particularly for the development of high-energy-density redox flow battery systems.

### SUMMARY

In view of the low resource utilization efficiency of scheelite, the present disclosure provides a method for short-process preparation of a heteropoly acid from scheelite and its application in redox flow battery. By combining tungsten ore hydrometallurgy with a redox flow battery electrolyte preparation process, the present disclosure innovatively provides a method for direct short-process production of a high-performance heteropoly acid for an electrolyte in a redox flow battery through in-situ decomposition of scheelite.

To achieve the above objective, a first aspect of the present disclosure provides a method for short-process preparation of a heteropoly acid from scheelite, including the following steps:
S1: Mixing the scheelite with sodium silicate at a W-to-Si molar ratio of (1-3):1, and conducting water leaching and acidolysis, such that WO₄²⁻ resulting from decomposition and SiO₃²⁻ self-assemble under an acidic condition to produce silicotungstic acid with a Keggin structure; and conducting solid-liquid separation. The silicotungstic acid with the Keggin structure has a molecular formula H₄[SiW₁₂O₄₀]·xH₂O, where x represents a number of water molecules of crystallization and is not a fixed value. x depends on a cation type, a synthesis and purification method, a storage duration, etc. In the present disclosure, x is 9 to 17.
S2: Adding a precipitating agent to the leachate to produce a silicotungstate precipitate, thereby achieving preliminary purification of the silicotungstic acid with the Keggin structure. The precipitating agent can react with the silicotungstic acid to produce the silicotungstate precipitate, which is a salt compound with low solubility.
S3: Redissolving the silicotungstate precipitate obtained in the S2, and conducting acidification, extraction, and recrystallization to produce silicotungstic acid with a battery-grade purity.

Preferably, in the S1, the scheelite has been purified early, and has a tungsten grade of higher than 40% and a particle size of 0.038 mm to 0.074 mm.

Specifically, in the S1, the water leaching is conducted for 1.0 h to 2.0 h at 75° C. to 90° C. with a solid-to-liquid ratio of 1 g:(1-2 mL).

Specifically, in the S1, the acidolysis is conducted for 2.5 h to 5.0 h at a pH of 4.5 to 5.5 and a temperature of 90° C. to 100° C. with a solid-to-liquid ratio of 1:(3-10). That is, a ratio of a total mass of the scheelite and the sodium silicate to a total volume of water and an acid for the acidolysis is 1:(3-10).

Specifically, in the S1, the molecular formula of silicotungstic acid with the Keggin structure is H₄[SiW₁₂O₄₀]·xH₂O.

Preferably, in the S2, the precipitating agent is one or more of ammonium chloride, potassium chloride, sodium chloride, and tetrabutylammonium chloride.

Preferably, in the S3, the redissolving is conducted at 40° C. to 50° C.

Preferably, in the S3, the acidification is conducted using hydrochloric acid, the extraction is conducted with diethyl ether, and a ratio of a weight of the silicotungstic acid, a volume of water, a volume of the hydrochloric acid, and a volume of the diethyl ether is 2:5:3:2.

Further preferably, in the S3, the acidification-extraction is conducted 2 times to 3 times, and the recrystallization is conducted 2 times or more.

A second aspect of the present disclosure provides a use of a heteropoly acid prepared by the method described above in preparation of an electrolyte for a redox flow battery.

With the aforementioned technical solutions, the present disclosure achieves the following beneficial effects:
1. The present disclosure innovatively provides a method for direct short-process production of high-performance silicotungstic acid with a Keggin structure for an electrolyte in a redox flow battery through in-situ decomposition of scheelite. This method achieves the clean and efficient utilization of tungsten resources, and opens a new technical pathway for the short-process preparation of electrolytes for heteropoly acid-based RFBs. The direct production of a silicotungstic acid electrolyte material from a tungsten ore raw material can significantly reduce the production cycle and cost of redox flow battery electrolytes, markedly alleviate the environmental pollution, and provide a new solution for the storage of renewable energy such as solar energy and wind power.
2. When the silicotungstic acid with the Keggin structure prepared by the present disclosure is used as a negative-electrode electrolyte of a redox flow battery, 12-electron reversible redox can be achieved at most in the silicotungstic acid (H₄[SiW₁₂O₄₀]·xH₂O) to achieve the state-of-charge (SoC) of 100%, which facilitates the further construction of high-energy-density redox flow battery systems.

### BRIEF DESCRIPTION OF THE DRAWINGS

FIG. 1 is a flow chart of short-process preparation of a heteropoly acid in an embodiment of the present disclosure;

FIG. 2 shows a three-layer liquid distribution during an extraction process of Keggin-type silicotungstic acid in an embodiment of the present disclosure;

FIG. 3 shows a Keggin-type silicotungstic acid-diethyl ether extraction mixture in an embodiment of the present disclosure;

FIG. 4 shows a Keggin-type silicotungstic acid product in an embodiment of the present disclosure;

FIG. 5 shows a cyclic voltammetry curve of Keggin-type silicotungstic acid in an embodiment of the present disclosure; and

FIG. 6 shows coulombic efficiency and capacity curves of a redox flow battery including 0.2 mol/L Keggin-type silicotungstic acid during 1 e⁻ to 12 e⁻ capacity charge-discharge cycles in an embodiment of the present disclosure.

### DETAILED DESCRIPTION OF THE EMBODIMENTS

The specific embodiments of the present disclosure will be described in detail below in conjunction with examples. It should be understood that the specific embodiments described herein are merely intended to illustrate and explain the present disclosure, rather than to limit the present disclosure.

In the following examples, scheelite is natural high-purity scheelite (with a CaWO₄₍ₛ₎ content of higher than 99% and a WO₃ content of higher than 79%), and the scheelite is crushed and ground to a particle size of 0.038 mm to 0.074 mm.

### Example 1

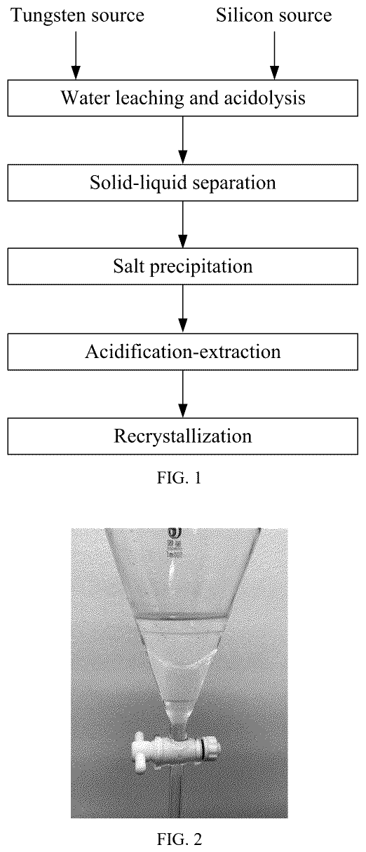

As shown in FIG. 1, a method for short-process preparation of a heteropoly acid was as follows:

### (1) Decomposition of Scheelite and Synthesis of Silicotungstic Acid

50 g of a scheelite powder with calcium tungstate (CaWO₄₍ₛ₎) as a main component and 20.88 g of sodium silicate (Na₂SiO₃) were weighed as precursors, and added to a bottom of a three-neck flask. An appropriate amount of 80° C. deionized water was added, and water leaching was conducted for 1.5 h. 4.0 mol/L hydrochloric acid was slowly added dropwise under vigorous stirring, and a reaction was conducted for 4.0 h at a pH of 4.5 to 5.5 and a temperature of 90° C. with a solid-to-liquid ratio of 3. After the reaction was completed, a resulting reaction mixture was filtered for solid-liquid separation to produce a filtrate including silicotungstic acid with a Keggin structure at a specified content.

### (2) Purification to Produce a Battery-Grade Silicotungstic Acid Electrolyte

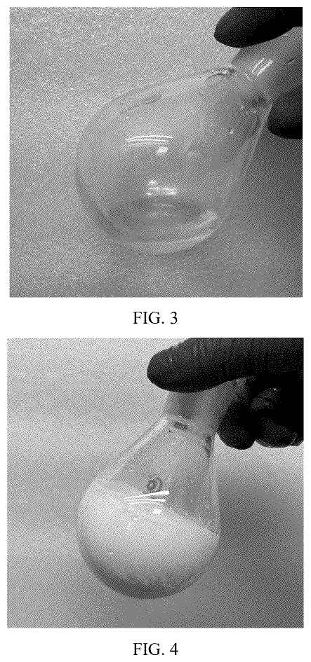

A salt compound such as ammonium chloride, potassium chloride, sodium chloride, or tetrabutylammonium chloride was added to the filtrate, such that the salt compound reacted with the silicotungstic acid to produce a silicotungstate precipitate with low solubility, thereby achieving preliminary purification of the silicotungstic acid with the Keggin structure. The silicotungstate precipitate was dissolved in deionized water at 45° C., concentrated hydrochloric acid and diethyl ether were added, and shaking was fully conducted (as shown in FIG. 2, during an extraction process of the silicotungstic acid with the Keggin structure, a three-layer liquid distribution was formed, including a diethyl ether layer, an impurity-containing mixed leachate layer, and a silicotungstic acid-diethyl ether extraction layer sequentially from top to bottom). The silicotungstic acid-diethyl ether extraction layer was transferred to a separatory funnel (FIG. 3 shows a Keggin-type silicotungstic acid-diethyl ether extraction mixture), and hydrochloric acid acidification-diethyl ether extraction was conducted once again. The hydrochloric acid acidification-diethyl ether extraction was repeated twice. A final oily solution at a bottom of a separatory funnel was subjected to evaporation with a rotary evaporator for drying to produce silicotungstic acid (as shown in FIG. 4). To ensure the purity, the silicotungstic acid was subjected to recrystallization three times to produce silicotungstic acid with a battery-grade purity (where a silicotungstic acid content was higher than or equal to 99.5%, impurity contents of Na, K, Ca, Fe, Zn, and Cl all did not exceed 0.003%, and the leaching rate of scheelite was 99.54%). When the silicotungstate precipitate was redissolved and subjected to acidification-extraction, the ratio of a weight of the silicotungstic acid, a volume of the deionized water, a volume of the hydrochloric acid, and a volume of the diethyl ether was essentially 2:5:3:2.

### (3) Testing of a Silicotungstic Acid-Based Redox Flow Battery

A negative-electrode electrolyte was prepared using the purified silicotungstic acid with the Keggin structure as an active material. The negative-electrode electrolyte included 0.2 mol/L of silicotungstic acid and 2.5 mol/L of sulfuric acid. With the negative-electrode electrolyte, 1.5 mol/L of vanadyl sulfate (VOSO₄)+3.0 mol/L of sulfuric acid as a positive-electrode electrolyte, a proton exchange membrane Nafion 117, a graphite felt as both positive and negative electrode materials, a test fixture, and other components, an asymmetric aqueous redox flow battery was assembled and tested for battery performance. A test method was as follows: The asymmetric aqueous redox flow battery was charged and discharged at a constant current of 100 mA/cm², with a capacity (namely, a capacity corresponding to SoC of the silicotungstic acid) as a charge termination condition and 0 V as a discharge termination condition.

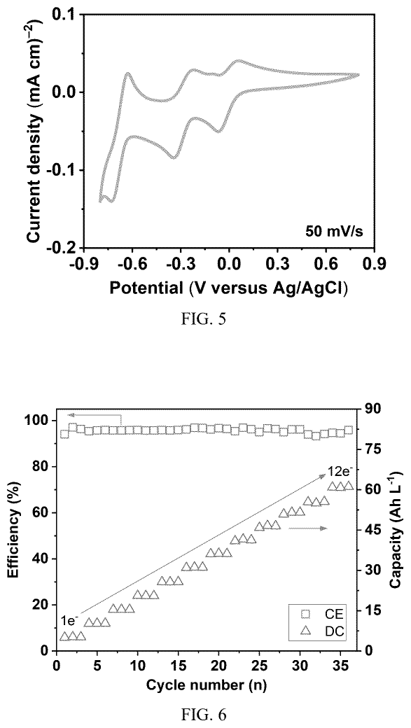

Test results were shown in FIG. 5 and FIG. 6.

As shown in FIG. 5, the silicotungstic acid with the Keggin structure prepared from scheelite exhibits three pairs of reversible redox peaks, and the three pairs of reversible redox peaks have consistent shapes and positions with those of commercial silicotungstic acid, indicating the successful synthesis of silicotungstic acid.

As shown in FIG. 6, the silicotungstic acid-based redox flow battery system demonstrates stable charge and discharge performance with stepwise electron (1 e⁻ to 12 e⁻) cut-off. Therefore, the silicotungstic acid with the Keggin structure is an ideal candidate material for designing multi-electron transfer electrolytes required for high-energy-density redox flow battery systems.

A negative electrode of a Keggin-type silicotungstic acid-based redox flow battery can achieve 12-electron reversible redox at most, which facilitates the further construction of high-energy-density redox flow battery systems (in contrast to 1-electron reversible redox of VRFBs).

### Example 2

### (1) Decomposition of Scheelite and Synthesis of Silicotungstic Acid

50 g of a scheelite powder with calcium tungstate (CaWO₄₍ₛ₎) as a main component and 10.44 g of sodium silicate (Na₂SiO₃) were weighed as precursors, and added to a bottom of a three-neck flask. An appropriate amount of 90° C. deionized water was added, and water leaching was conducted for 1.0 h. 5.0 mol/L hydrochloric acid was slowly added dropwise under vigorous stirring, and a reaction was conducted for 2.5 h at a pH of 4.5 to 5.5 and a temperature of 100° C. with a solid-to-liquid ratio of 10. After the reaction was completed, a resulting reaction mixture was filtered for solid-liquid separation to produce a filtrate including silicotungstic acid with a Keggin structure at a specified content.

### (2) Purification to Produce a Battery-Grade Silicotungstic Acid Electrolyte

A salt compound such as ammonium chloride, potassium chloride, sodium chloride, or tetrabutylammonium chloride was added to the filtrate, such that the salt compound reacted with the silicotungstic acid to produce a silicotungstate precipitate with low solubility, thereby achieving preliminary purification of the silicotungstic acid with the Keggin structure. The silicotungstate precipitate was dissolved in deionized water at 40° C., concentrated hydrochloric acid and diethyl ether were added, and shaking was fully conducted. The bottom layer of resulting mixed solution was transferred to a separatory funnel, and hydrochloric acid acidification-diethyl ether extraction was conducted once again. The hydrochloric acid acidification-diethyl ether extraction was repeated twice. A final oily solution at the bottom of a separatory funnel was subjected to evaporation with a rotary evaporator for drying to produce silicotungstic acid. To ensure the purity, the silicotungstic acid was subjected to recrystallization three times to produce silicotungstic acid with a battery-grade purity. When the silicotungstate precipitate was redissolved and subjected to acidification-extraction, a ratio of a weight of the silicotungstic acid, a volume of the deionized water, a volume of the hydrochloric acid, and a volume of the diethyl ether was essentially 2:5:3:2. In the silicotungstic acid with a battery-grade purity, a silicotungstic acid content was higher than or equal to 99.5%, impurity contents of Na, K, Ca, Fe, Zn, and Cl all did not exceed 0.003%, and a leaching rate of scheelite was 99.70%.

### Example 3

### (1) Decomposition of Scheelite and Synthesis of Silicotungstic Acid

50 g of a scheelite powder with calcium tungstate (CaWO₄₍ₛ₎) as a main component and 6.96 g of sodium silicate (Na₂SiO₃) were weighed as precursors, and added to a bottom of a three-neck flask. An appropriate amount of 75° C. deionized water was added, and water leaching was conducted for 2.0 h. 3.0 mol/L hydrochloric acid was slowly added dropwise under vigorous stirring, and react for 5.0 h at the pH of 4.5 to 5.5 and the temperature of 75° C. with the solid-to-liquid ratio of 6. After the reaction was completed, the resulting reaction mixture was filtered for solid-liquid separation to produce a filtrate including silicotungstic acid with a Keggin structure at a specified content.

### (2) Purification to Produce a Battery-Grade Silicotungstic Acid Electrolyte

A salt compound such as ammonium chloride, potassium chloride, sodium chloride, or tetrabutylammonium chloride was added to the filtrate, such that the salt compound reacted with the silicotungstic acid to produce a silicotungstate precipitate with low solubility, thereby achieving preliminary purification of the silicotungstic acid with the Keggin structure. The silicotungstate precipitate was dissolved in deionized water at 40° C., concentrated hydrochloric acid and diethyl ether were added, and shaking was fully conducted. A bottom layer of a resulting mixed solution was transferred to a separatory funnel, and hydrochloric acid acidification-diethyl ether extraction was conducted once again. The hydrochloric acid acidification-diethyl ether extraction was repeated three times. A final oily solution at the bottom of a separatory funnel was subjected to evaporation with a rotary evaporator for drying to produce silicotungstic acid. To ensure the purity, the silicotungstic acid was subjected to recrystallization twice to produce silicotungstic acid with a battery-grade purity (where a silicotungstic acid content was higher than or equal to 99.5%, impurity contents of Na, K, Ca, Fe, Zn, and Cl all did not exceed 0.003%, and a leaching rate of scheelite was 99.62%). When the silicotungstate precipitate was redissolved and subjected to acidification-extraction, a ratio of a weight of the silicotungstic acid, a volume of the deionized water, a volume of the hydrochloric acid, and a volume of the diethyl ether was essentially 2:5:3:2.

Preferred embodiments of the present disclosure are described in detail above, but the present disclosure is not limited to specific details in the above embodiments. Various simple variations can be made to the technical solutions of the present disclosure without departing from the technical ideas of the present disclosure, and these simple variations fall within the protection scope of the present disclosure.

In addition, it should be noted that various specific technical features described in the above specific embodiments can be combined in any suitable manner, provided that there is no contradiction. To avoid unnecessary repetition, various possible combination modes of the present disclosure are not described separately.

Different implementations of the present disclosure can also be combined arbitrarily. Such combination should also be regarded as the content disclosed in the present disclosure, provided that the combination does not deviate from the spirit of the present disclosure.

1. A method for short-process preparation of a heteropoly acid from scheelite, comprising following steps:
S1, mixing the scheelite with sodium silicate at a W-to-Si molar ratio of (1-3):1, and conducting water leaching and acidolysis, such that WO₄²-resulting from decomposition and SiO₃²-self-assemble under an acidic condition to produce silicotungstic acid with a Keggin structure; and conducting solid-liquid separation;
S2, adding a precipitating agent to a leachate to produce a silicotungstate precipitate, thereby achieving preliminary purification of the silicotungstic acid with the Keggin structure, wherein the precipitating agent is one or more of ammonium chloride, potassium chloride, sodium chloride, and tetrabutylammonium chloride; and
S3, redissolving the silicotungstate precipitate obtained in the S2, and conducting acidification, extraction, and recrystallization to produce silicotungstic acid with a battery-grade purity.

2. The method according to claim 1, wherein in the S1, the scheelite has a tungsten grade of higher than 40% and a particle size of 0.038 mm to 0.074 mm.

3. The method according to claim 1, wherein in the S1, the water leaching is conducted for 1.0 h to 2.0 h at 75° C. to 90° C. with a solid-to-liquid ratio of 1 g:(1-2 mL).

4. The method according to claim 1, wherein in the S1, the acidolysis is conducted for 2.5 h to 5.0 h at a pH of 4.5 to 5.5 and a temperature of 90° C. to 100° C. with a solid-to-liquid ratio of 1 g:(3-10 mL).

5. The method according to claim 1, wherein in the S3, the redissolving is conducted at 40° C. to 50° C.

6. The method according to claim 1, wherein in the S3, the acidification is conducted using hydrochloric acid, and the extraction is conducted using diethyl ether.

7. The method according to claim 6, wherein in the S3, the acidification-extraction is conducted 2 times to 3 times, and the recrystallization is conducted 2 times or more.

8. A use of a heteropoly acid prepared by the method according to any one of claims 1 to 7 in preparation of an electrolyte for a redox flow battery.
